(19) United States
(12) Patent Application Publication
(10) Pub. No.: US 2023/0133299 A1
(43) Pub. Date: May 4, 2023

(54) Nail Salon Bio-hazardous Dust and Fume Source Capture Ventilation to Automatically Operate at Individual Manicure and Pedicure Work Stations for Conserving Preconditioned Room Air and Preventing Cross Contamination.

(71) Applicant: David Joseph Lucas, Ortonville, MI (US)

(72) Inventor: David Joseph Lucas, Ortonville, MI (US)

(21) Appl. No.: 17/514,117

(22) Filed: Oct. 29, 2021

(51) Int. Cl. B08B 15/00; F24F 7/007; F24F 8/95

(52) U.S. Cl. CPC B08B 15/002; F24F 7/007; F24F 8/95; F24F 2007/001

(57) ABSTRACT

A nail salon bio-hazardous dust and fume source capture ventilation apparatus and system to automatically operate at individual manicure and pedicure work stations including means for conserving preconditioned room air and preventing cross contamination between work stations while reducing fan noise without filters.

### CROSS-REFERENCE TO RELATED APPLICATIONS

Provisional Application 63/182,963

### STATEMENT REGARDING FEDERALLY SPONSORED RESEARCH OR DEVELOPMENT

Nat Applicable

### REFERENCE TO SEQUENCE LISTING A TABLE, OR A COMPUTER PROGRAM LISTING COMPACT DISC APPENDIX

Not Applicable

### BACKGROUND OF THE INVENTION

In the past, nail salons have employed dust and fume source capture systems that incur wasteful exhaust of air-conditioned air regardless of the amount of ventilation required. Other systems have been developed with filters to recycle the air in an attempt to overcome this deficiency but require frequent filter or filter media replacement and are not efficient. Systems with multiple fans have been employed but result in cross contamination between workstations when attached to a common exhaust and are further problematic as noise generated increases with each fan in use. It is the intent of the present invention to overcome all of these deficiencies.

### BRIEF SUMMARY OF THE INVENTION

The present invention generally relates to an apparatus and method for venting dust and fumes created at a nail salon during manicures and pedicures. The invention is specifically designed to capture dust and fumes at the source of theft creation at workstations and vent it safely to the outdoors.

An object of the invention is to conveniently minimized the amount of venting to conserve costly air conditioning resources for heating and cooling that are utilized in nail salons to maintain comfort.

Another object of the invention is to prevent cross contamination of potentially, biohazardous dust and fumes between work stations.

A further object of the invention is to minimize noise in nail salons caused by operating multiple ventilation fans at the same time.

It is a further object of the invention to eliminate the use of filters employed for recycling vented air in a nail salon.

### BRIEF DESCRIPTION OF THE SEVERAL VIEWS OF THE DRAWING

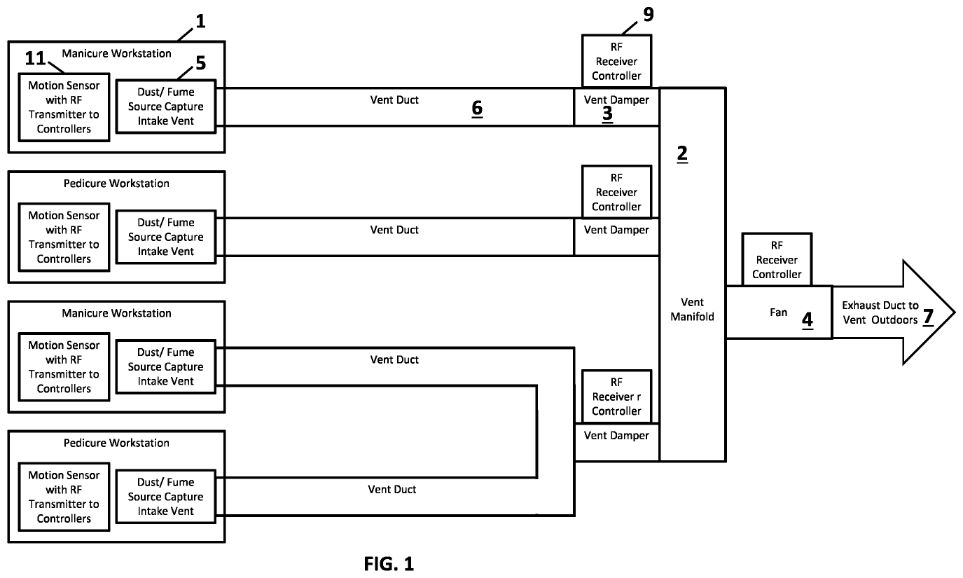

Page 1-3 FIG. 1 is a block diagram of the invention providing reference of how the major system components relate to each other.

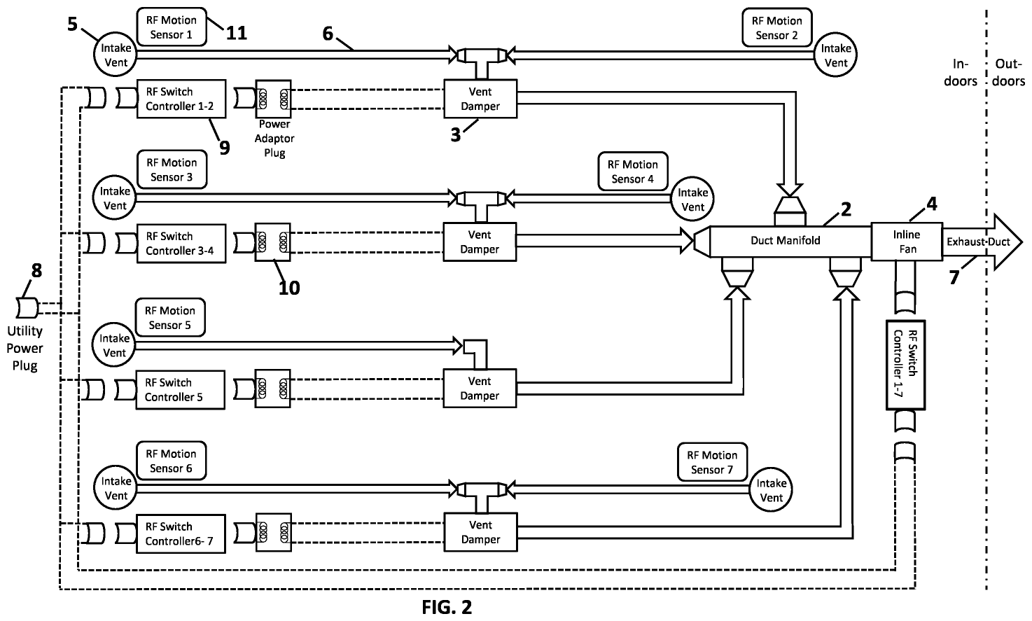

Page 2-3 FIG. 2 is a practical example of the invention including electrical and mechanical interfaces between components.

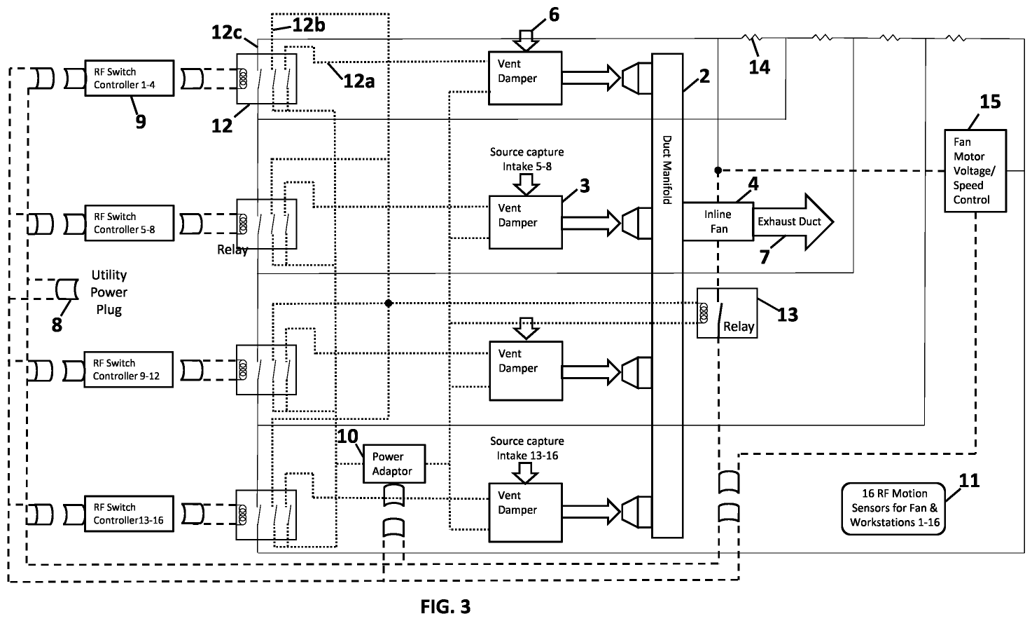

Page 3-3 FIG. 3 is a description that includes specific detail of a fan speed control configuration included as part of the invention.

### DETAILED DESCRIPTION OF THE INVENTION

The present invention operates venting of potential biohazardous dust and fumes created in a nail salon at individual manicure and pedicure workstations to the outdoors only when human motion presence is detected at an individual manicure or pedicure workstation, and thus, eliminating excess venting when dust and fumes are not being created. This excess venting can be a substantial amount of wasteful venting of preconditioned heated or cooled air in the workstation environment as there are typically several unoccupied manicure and pedicure workstations in a single air-conditioned room or building (nail salon).

The invention further provides a substantial reduction in noise because the invention employs the use of a single fan instead of multiple fans employed for several workstations.

The invention further prevents cross contamination of potential biohazard to adjacent work stations as a vacuum is created within a manifold that connects the several workstations, which is a hazardous deficiency in systems with positive manifold pressure that employ multiple fans that push exhaust air towards adjacent work stations.

The invention further requires only a single exhaust to the outdoors and does not require filters.

Referring to the drawing sheets 1 and 2, the present invention is for automatically venting potential biohazardous dust and fumes created in a nail salon at individual manicure and pedicure workstations 1 to the outdoors only when needed. The invention includes an air duct manifold 2 with several standard motorized inlet air duct dampers 3 directly connected to manifold 2, or optionally connected with additional air duct to said manifold. Manifold 2 also has a standard inline ventilation exhaust fan 4 connected to it. Dust and fume source capture intake vents 5 integral to pedicure and manicure workstations 1 are connected to dampers 3 with standard air ducts 6. Air ducts 6 may be of a metal, plastic, vacuum hose, or the like, preferably three-inch diameter for applications requiring ducts to fit within a framed room wall. Air duct 7 is also connected to fan 4 to exhaust said dust and fumes to the outdoors. Fan 4 creates a vacuum within manifold 2 thus preventing cross contamination between the several dampers 3.

Electric Utility power 8 is connected to several radio frequency (RF) receiver controllers 9. Controller 9 includes a switched power output that is connected to the integral motor of damper 3 to power open and close damper 3. Most available dampers operate at a different voltage than utility voltage and may require a standard available voltage adaptor 10 between controller 9 output and damper 3. One of the several controllers 9 is employed to switch power on and off to fan 4.

A wireless motion sensor 11 is placed at each manicure and pedicure workstation 1. Motion sensor 11 includes means to transmit an RF signal to an assigned receiver controller 9 for commanding damper 3 to open or close for the assigned workstation. More than one motion sensor 11 may be assigned to operate a single controller 9. All of the motion sensors 11 are programmed to also operate controller 9 that is employed to switch power on and off to fan 4. Wireless RF motion sensors and receiver controllers with the above stated functionality are well known to the art and it is not the intention of this invention to claim or describe their internal details.

Referring now to drawing sheet 3-3 FIG. 3 where another example of the invention above is described that also includes fan speed control for nail salons with a large quantity of work stations requiring an exhaust fan with a high total cubic foot per minute (cfm) venting capacity when venting all workstations simultaneously, and also includes the capability to vent only some of the work stations at a lower cfm. This configuration provides yet further efficiency and lower fan noise.

In this configuration of the invention the switched power output of controller 9 is connected to close the integral switched outputs 12a and 12b of relay 12 to power open and close damper 3 and simultaneously close integral switch of relay 13 to provide power to fan 4. A single power adaptor 10 is employed for power to dampers 3 and relay 13. Simultaneously with the closing of 12a and 12b, integral switched output 12c of relay 12 is closed to bypass resistor 14 thus lowering the total resistance of the several resistors 14 that provide speed input control to fan motor speed controller 15. As the number of workstations 1 are occupied and activate additional relays 12 the total resistance of resistors 14 is reduced thus increasing the speed of fan 4. Speed controller 15 is of the solid-state type for controlling shaded pole motors and the like typically used in residential 110 or commercial fan speed applications. These types of resistive input speed controllers are well known to the art and it is not the intention of this invention to claim or describe their internal details other than the above resistor speed control interface that is essential and distinctive to the operation of the invention.

In other configurations of the invention, remote RF transmitters such as wall 115 mounted, hand held or in combination with other RF equipment may be substituted for motion sensor 11, or, employ hard wired connections instead of wireless RF, or, employ solid state switching technologies instead of mechanical relays, and yet function in the same manner without deviating from the spirit and scope of the present invention.

1. An apparatus for venting dust and fumes created at a nail salon during manicures and pedicures, comprising;
A dust and fume intake vent located to capture dust and fumes at the source of their creation at a manicure or pedicure workstation (vented workstation);
wherein said workstation includes a motion sensor with integral RF transmitter located to detect and communicate the presence of human activity at said workstation;
wherein said intake vent is connected to one end of an air vent duct where opposite end of said duct is connected to one end of an electric motor-controlled air vent damper where opposite end of said damper is connected to a vent manifold;
wherein said damper is electrically connected to a damper controller that includes an integral RF receiver for opening and closing said damper's airway;
wherein said manifold is connected to one end of an exhaust fan where opposite end of said fan is mounted to exhaust to the outdoors;
wherein said fan is electrically connected to a fan controller that includes an integral RF receiver for activating said fan;
wherein the apparatus contains any multiple of said vented workstations connected to said damper;
wherein the apparatus contains any multiple of said dampers connected to said manifold.

2. The apparatus of claim 1, wherein said motion sensor communicates to said damper controller and said fan controller to open said damper and activate said fan when the presence of human activity at said workstation is detected; and
closes said damper and does not activate said fan when there is no presence of human activity detected at said workstation.

3. The apparatus of claim 1, wherein said motion sensor of any of said multiple of said vented workstations communicates to said fan controller to activate said fan when the presence of human activity is detected.

4. The apparatus of claim 1, wherein an electrical fan relay is electrically connected to said fan; instead of said fan controller, for activating said fan;
wherein an electrical fan speed controller is electrically connected to said fan;
wherein fan speed control selection resistors are electrically connected in series to said speed controller;
wherein an electrical damper relay is electrically connected between said damper controller and said damper for opening and closing said damper's airway; and
said damper relay is electrically connected to said fan relay to activate said fan relay; and
wherein said damper relay is electrically connected to make a short circuit across one of the said fan speed control selection resistors to reduce the total speed control resistance of said speed control selection resistors to set the speed of said fan;
wherein any multiple of said vented workstation's damper relays are able to simultaneously make a short circuit across another one of the separate said fan speed control selection resistors to progressively reduce the total speed control resistance of said speed control selection resistors to progressively increase the speed of said fan (in reverse, as short circuits are removed, the fan speed is reduced).
